(19) United States
(12) Patent Application Publication
(10) Pub. No.: US 2008/0268132 A1
(43) Pub. Date: Oct. 30, 2008

(54) EFFERVESCENT FOOD PRODUCTS

(75) Inventor: James D. HANSA, Algonquin, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: THE QUAKER OATS COMPANY, Chicago, IL (US)

(21) Appl. No.: 11/739,221

(22) Filed: Apr. 24, 2007

(51) Int. Cl. A23L 1/10

(52) U.S. Cl. 426/626; 426/506

(57) ABSTRACT

A food product comprising a fizz component that causes the product to fizz or have an effervescent effect upon addition of aqueous liquid.

### FIELD OF THE INVENTION

The present invention relates generally to food products, and more particularly to effervescent food products.

### BACKGROUND OF THE INVENTION

A variety of food products is available to the consumer. For many years, cereal food products have been a staple of the human diet. Such cereal food products include, for example, cold breakfast cereal and hot instant oatmeal or regular oatmeal. Cereal products are viewed as healthy and nutritious. Due to the nutritional value, parents desire that their children consume cereal products. Although cereal products have been developed to appeal to a broad range of consumers by having a wide range of shapes, flavors, colors, nutritional values, textures as well as form and preparation, it may sometimes be difficult to encourage children to eat nutritious food. This is because children often perceive nutritious food as not having good taste or as not being fun to eat.

The foregoing illustrates the need for a food product and particularly a cereal product that is fun to eat to encourage consumption, particularly among children.

### SUMMARY OF THE INVENTION

A first embodiment of the invention relates to a food product that has a fizz component. A second embodiment of the invention relates to a cereal product that has a fizz component.

### DETAILED DESCRIPTION OF THE INVENTION

The invention relates to a food product. The food product comprises a fizz component. As described herein, a fizz component is a compound or combination of compounds that release gas to make the food product fizz upon contact with aqueous liquid.

In one embodiment, the food product comprises a cereal product that has a fizz component. The cereal product can be formed from various types of grains such as oats, rice, corn, wheat, or barley. Forming the cereal product from a combination of grains (e.g., multi-grain) is also useful. Preferably, the cereal product comprises oats, corn, wheat, or a combination thereof. Additional ingredients, such as sweeteners, flavorings, colorings, vitamins, minerals, preservatives, and other compositions known to the skilled practitioner, can be added, as desired.

In one embodiment, the cereal product comprises a hot cereal product. The cereal product can be of the instant type, such as instant oatmeal, corn grits or wheat grits, which can be prepared by adding hot liquid. The hot liquid, for example, can be water. Other types of liquids, such as milk and fruit juices, are also suitable liquids. Typically, the liquid is at a temperature close to or equal to its boiling point. Lower temperatures may also be suitable. Non-instant types of cereal products also can contain a fizz component. Such cereal products are prepared by adding liquid and cooking the mixture.

The food product comprising a fizz component can be any food that can exhibit a “fizz” or effervescent effect. Thus, a food product such as a dry sauce mix (e.g., for a gravy or pasta sauce) comprising a fizz component is contemplated within the scope of the invention. Such a product could serve, for example, as a novelty product. However, for convenience, the invention is described herein primarily as it relates to products for children, and especially to cereal products for children. Further, as the products comprising a fizz component, all components, reactants, initiators, by-products, and reaction products should be edible or not be harmful to the consumer.

In accordance with one embodiment of the invention, the cereal product comprises a fizz component. The fizz component reacts when subjected to liquid aqueous initiator to fizz or exhibit an effervescent effect. The liquid can be any liquid that initiates the fizz effect. Typically cereal products are mad with water, which can be a suitable initiator. Other aqueous liquids, such as milk, buttermilk, fruit juice, and yogurt also are useful. A combination of different liquids also is useful.

The liquid can be hot or cold, depending upon the requirements of the fizz component. In one embodiment, the fizz component reacts when subjected to hot liquid. The temperature of the hot liquid, in one embodiment, is close to or at its boiling point. Other temperatures may also useful. Any temperature that is able to initiate the reaction that causes the fizz or effervescent effect is suitable.

The fizz component typically comprises acid and base components. Any food grade combination of acid and base components that provides effervescence to the food product essentially without adversely affecting the organoleptic properties and characteristics of the food product is suitable. Thus, any acid/base pair that provides a release of gas from the base to “fizz” the products is suitably used. Typically, the acid will be a food grade acid having a concentration sufficient to react with a food grade base that liberates a gas, typically carbon dioxide (CO₂), to provide the “fizz” or effervescent effect.

Any food grade acid may be used. The acid is selected to ensure that the effervescent effect is realized yet the flavor of the food product is not adversely affected. In one embodiment, the acid component preferably comprises an anhydrous acid selected from the group consisting of tartaric, malic, fumaric, adipic, succinic, acetic, lactic, propionic, sorbic, phosphoric, and blends thereof. More preferably, the acid component comprises citric acid.

The base component comprises any food grade basic compound that releases a gas upon reaction with the acid component to product the fizz or the effervescent effect. The gas released is limited only by the need to produce an edible food product. Thus, the smell of the gas should be pleasant or inoffensive. Carbon dioxide gas is a preferred gas.

In one embodiment, the base component is selected from the group consisting of carbonate or bicarbonate of sodium, potassium, calcium, ammonium, and blends thereof. Preferably, the base component comprises calcium carbonate, sodium bicarbonate, or a combination thereof.

The relative proportions of base component and acid component are established to ensure that the fizz or effervescent effect is achieved efficiently, without leaving excess base or acid component unreacted in the product. Unreacted base or acid component might adversely affect the flavor of the food product. Typically, therefore, as the skilled practitioner recognizes, a stoichiometric quantity of acid and base is utilized with essentially no excess of either acid or base. This method is used to ensure that essentially all of the base and acid components have been consumed by the effervescence reaction. Any minor amount of either acid or base component that has not reacted thus will remain in the food product, typically without adversely affecting the organoleptic properties and characteristics of the food product.

In one embodiment, the fizz component comprises between about 0.01 and about 10 weight percent, typically between about 0.05 and about 5 weight percent of acid component, and between about 0.01 and about 10 weight percent, typically between about 0.05 and about 5 weight percent of base component, both based on the total weight of the food product. Preferably, the fizz component comprises stoichiometric quantities of each component. Typically, therefore, the molar ratio of acid component to base component is about 1:1 for bicarbonates to about 2:1 for carbonates. The skilled practitioner will, with the guidance provided herein, be able to determine an appropriate molar ratio. Other compositional ranges may also be useful.

A two-part (base and acid) fizz component typically is prepared prior to being added to the cereal food product. Preparation of the fizz component includes, for example, grinding the acid and base components into particles or powder. The grinding should result in an even distribution of the components. Preferably, the components are prepared to reduce formation of precipitates. This may be achieved by grinding the acid and base components together. Grinding the acid and base components separately followed by blending to produce an even distribution may yield a suitable fizz component.

The particle size of the fizz composition components is selected to, for example, achieve the desired reaction rate. Generally, reaction rate and particle size are inversely proportional. Typically, particles have an average particle size such that 95 weight percent of the particles are 42 mesh or finer. For example, higher reaction rate is achieved with smaller particles. In one embodiment, the average particle size of the components is established so that 95 weight percent of the particles are 80 mesh or finer. Providing a fizz component with components having other particle sizes may also be useful. The rate and duration of the effervescent effect will be different, as the skilled practitioner recognizes.

The prepared fizz component can be added to the cereal food product in various forms. In one embodiment, the prepared fizz component is added in dry form. For example, the fizz component is added as powder in the desired amount. The fizz component then is blended with the cereal food to produce an even distribution. To prevent premature reaction between the acid and base before the addition of an aqueous liquid, the moisture level of the cereal food should be sufficiently low. The moisture level, for example, should be less than about 15 weight percent, and preferably less than about 10 weight percent. Alternatively, the fizz component can be encapsulated. Fizz component that is encapsulated is precluded from reacting to form gas and exhibit an effervescent effect. Either component may be encapsulated to achieve this result. Often, however, as the acid component and the base component are mixed, especially before grinding, both components are encapsulated. However, care should be taken to ensure that the encapsulation is not breached during mixing of fizz components and cereal.

The encapsulant can be any food grade water-resistant coating. Often, such coatings comprise fat-based compositions that are fluid at elevated temperature but solidify at ambient temperature (about 20° C.—about 30° C.: about 68° F.—about 86° F.). Because the coating is solid at ambient temperatures, the acid component and the base component are precluded from reacting. However, the coating is breached at an elevated temperature, i.e., at a temperature at which the food product is prepared for consumption. Then, the acid and base components can combine to yield the effervescent effect, or the fizz.

Suitable coatings for the particulate include, for example, coatings described in U.S. Pat. No. 6,159,511, which is herein incorporated by reference for all purposes. Various types of edible fat-based coating can be used. Such edible fat can include, for example, cocoa, butter, coconut oil, soybean, cottonseed, sunflower, canola, partially hydrogenated vegetable oil, and combinations thereof. These and other fats can be used to form the basis of a coating for the acid and base component particles. Sugar can be also added to the coating for flavoring. Another suitable coating is Mor-Rex 1918, a hydrolyzed cereal solid having a dextrose equivalence of 10 available from CPC Industrial.

Other coatings also can be used. Waxes often are soluble in warm fluid appropriate for preparation of the food product. Also, a coating can comprise a water-absorbing polymer molecule interspersed in the coating. The water-absorbent polymer swells and disrupts the coating upon absorption of water. Then, the coating fails and the components can mix with each other.

To coat the acid and base components, a suitable coating is prepared and heated to become fluid. The acid and base components then are mixed into the fluid coating. The coating then is solidified by cooling and the coated, two-component mixture is used in the manufacture of a food product. The encapsulated product of this embodiment then can be solidified in a manner known in the art. A solid slab could be broken up, but crushing or comminating the slab is difficult to do well, i.e., to produce reasonably sized encapsulated products. Thus, particles often are formed by spray cooler, to form smaller, more easily managed and used drops. With the guidance provided herein, the skilled practitioner will be able to form encapsulated solid particles of acid and base components for inclusion in the product.

In another embodiment, the fizz component is further processed to form pellets. The pellets can be added to the cereal product in the desired amount. The processed pellets can be encased in a coating. In one embodiment, the coating comprises edible fat. The pellet coatings can include the material used to coat the individual particles, as described above. These coatings also can be include coating interrupters, as described, to ensure that the acid and base components react fully (and yield a complete “fizz” reaction).

The content of a fat-based coating is selected to have a desired melting point. When subjected to an aqueous liquid having a temperature greater than the melting point of the coating, the coating melts. The melt rate increases as the difference between the melting point and the liquid temperature increases. A water-soluble coating dissolves in the aqueous liquid. Dissolution rate typically is greater at higher liquid temperatures. This melting or dissolution of the coating exposes the fizz component to the aqueous liquid, resulting in the fizzing or effervescent effect.

In one embodiment, the coating melts at a predetermined temperature. The predetermined temperature, for example, is less than or equal to about the temperature of the hot liquid used to prepare the cereal product. In one embodiment, the predetermined melting point temperature is at about that of the hot liquid used to prepare the food. When the coating has water-absorbing swelling aid, these water-based inclusions in the coating react upon wetting and tend to break up the coating. Hot water, i.e., at or above the melting temperature of the fat-based material, will tend to melt more of the coating.

The time required to expose the fizz component can be determined by the thickness of the coating. The thicker the coating, the greater the time needed. The thickness of the coating is selected so that the fizz component becomes exposed to the liquid in from about two seconds to about ten minutes. Depending on the desired application or product, the exposure time may be shorter or longer. For example, the exposure time may be selected to provide a fizzing cereal product after it is prepared and ready for eating. As the skilled practitioner recognizes, the case of the coating would then be thicker for a non-instant type of cereal product than for an instant product to enable the pellets to withstand the cooking time before being melted or dissolved. Alternatively, the coated pellets may be added after the food is prepared and ready to eat, allowing the use of a relatively thinner coating. Thus, with the guidance provided, the skilled practitioner can determine a suitable coating thickness.

The cereal food product comprises a sufficient amount of fizz component to cause fizzing or an effervescent effect when an aqueous liquid is added. Preferably, the fizz component is present in a sufficient amount to produce fizzing for up to about ten minutes, and more typically for between about five seconds and five minutes. The fizz also can persist during eating of the product to provide a desirable mouth feel experience. For example, the duration time can be selected to be relatively short, providing initial attraction or entertainment but ceasing to fizz when about to be consumed. Similarly, coatings of various thicknesses can be applied to portions of the fizz component to provide fizzing or an effervescent effect for an extended period.

Preferably, the amount of fizz component is less than the quantity that would adversely impact the taste of the product. The taste can be adversely affected by the salt or other reaction products formed during the reaction, or by unreacted base acid or component. It may also be desirable to provide the fizz component at levels which do not impart a substantial degree of gas, particularly carbonation, to the aqueous liquid. In one embodiment, the fizz component comprises between about 0.01 weight percent and about 10 weight percent, more typically between about 0.05 weight percent and about 5 weight percent of the total weight of the cereal food product, excluding the aqueous liquid. Other percentages of fizz component may also useful.

In yet another embodiment, fizz component may be provided in a combination of different forms to the cereal product. In another embodiment, the fizz component can be a carbonation source for hot food products, such as, for example, instant or non-instant hot beverages.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

1. A food product comprising:
a cereal-based food component;
a fizz composition including acid and base components, wherein the fizz composition reacts to create fizzing in the food product when combined with an aqueous liquid.

2. The food product of claim 1, wherein the acid component is selected from the group consisting of tartaric, malic, fumaric, adipic, succinic, acetic, lactic, propionic, sorbic, phosphoric, and blends thereof.

3. The food product of claim 1, wherein the base component is selected from the group consisting of carbonate and bicarbonate of sodium, potassium, calcium, ammonium, and blends thereof.

4. The food product of claim 2, wherein the base component is selected from the group consisting of carbonate and bicarbonate of sodium, potassium, calcium, ammonium, and blends thereof.

5. The food product of claim 1, wherein the fizz component comprises between about 0.05 and about 5 weight percent acid component and between about 0.05 and about 5 weight percent base component, based on the total weight of the food product.

6. The food product of claim 4, wherein the fizz component comprises between about 0.05 and about 5 weight percent acid component and between about 0.05 and about 5 weight percent base component, based on the total weight of the food product.

7. The food product of claim 1, wherein the acid component and the base component are encapsulated.

8. The food product of claim 4, wherein the acid component and the base component are encapsulated.

9. The food product of claim 6, wherein the acid component and base component are encapsulated.

10. A method of preparing a food product, comprising:
providing a cereal-based food component;
adding a fizz composition comprising acid and base components to the cereal-based food component; and
adding an aqueous liquid to the cereal-based food component comprising fizz composition to react the fizz composition components and create fizzing in the food product.

11. The method of claim 10, wherein the acid component is selected from the group consisting of tartaric, malic, fumaric, adipic, succinic, acetic, lactic, propionic, sorbic, phosphoric, and blends thereof.

12. The method of claim 10, wherein the base component is selected from the group consisting of carbonate and bicarbonate of sodium, potassium, calcium, ammonium, and blends thereof.

13. The method of claim 12, wherein the base component is selected from the group consisting of carbonate and bicarbonate of sodium, potassium, calcium, ammonium, and blends thereof.

14. The method of claim 10, wherein the fizz component comprises between about 0.05 and about 5 weight percent acid component and between about 0.05 and about 5 weight percent base component, based on the total weight of the food product.

15. The method of claim 14, wherein the fizz component comprises between about 0.05 and about 5 weight percent acid component and between about 0.05 and about 5 weight percent base component, based on the total weight of the food product.

16. The method of claim 10, wherein the acid component and the base component are encapsulated.

17. The method of claim 14, wherein the acid component and the base component are encapsulated.

18. The method of claim 15, wherein the acid component and the base component are encapsulated.
